(19) United States
(12) Patent Application Publication
(10) Pub. No.: US 2007/0203909 A1
(43) Pub. Date: Aug. 30, 2007

(54) Methods, systems, and computer program products for indexing, validating, recovering, and consolidating a database indexed by range-bound numeric data

(75) Inventor: Rohini Marathe, Cary, NC (US)

Correspondence Address: JENKINS, WILSON, TAYLOR & HUNT, P. A., SUITE 1200, UNIVERSITY TOWER, 3100 TOWER BOULEVARD, DURHAM, NC, 27707, US

(73) Assignee: Tekelec

(21) Appl. No.: 11/364,759

(22) Filed: Feb. 28, 2006

(51) Int. Cl. G06F 7/00

(52) U.S. Cl. 707/7

(57) ABSTRACT

Methods, systems, and computer program products for indexing, validating, recovering, and consolidating a database indexed by range-bound numeric data are disclosed. According to one method, at least one index is computed based on a first key within a first range of numeric data. An entry corresponding to the index is accessed in a database having entries indexed by range-bound numeric data. From the entry, a bitmap having bits indicating the presence or absence of data corresponding to different keys within the first range of numeric data is read. Data corresponding to the first key is located using the bitmap.

### TECHNICAL FIELD

The subject matter described herein relates to accessing data indexed by ranges of numbers. More particularly, the subject matter described herein relates to methods, systems, and computer program products for indexing, validating, recovering, and consolidating a database indexed by range-bound numeric data.

### BACKGROUND ART

In telecommunications networks, databases are often indexed by ranges of numbers, such as ranges of telephone numbers (TNs). For example, number portability databases, such as local number portability databases, are indexed based on the first six digits of a telephone number, referred to as the numbering plan/exchange address and subsequent four digits. The first six digits of a TN are commonly referred to as the NPA-NXX. The NPA-NXX is common to ten thousand numbers, because the remaining four digits of a telephone number can range from 0000 to 9999. If a number within an NPA-NXX range is ported, its entry in the number portability database will contain a location routing number (LRN), which is a ten digit number corresponding to a ported-to end office.

One problem with conventional telecommunications databases, such as number portability databases, is that the databases are increasing in size, which results in increased storage requirements and lookup time. For example, number portability databases have increased in size in the United States and in other countries to include entries for hundreds of millions of subscribers. Such databases are typically implemented using binary tree data structures. In order to locate an entry in a b-tree data structure, a search key, such as a called party telephone number, is compared with data associated with different branches in the tree. As the number of ported telephone numbers increases, the number of branches in the tree increases and the search time increases. Another problem with using b-trees is that sophisticated balancing algorithms are required to ensure that the trees do not become unbalanced. B-tree structures have another problem associated with the high overhead for the key associated with each entry. The size of key may be greater than the size of data associated with a key. As database size grows, there is a need to minimize the key overhead associated with each data entry. Resulting in a more compact structure for large databases.

Yet another problem associated with conventional telecommunications databases is that existing validation methods may not indicate whether results of a database access are valid. For example, when a number portability database is accessed and an LRN is retrieved, there is no way using current databases to determine whether the retrieved LRN is in fact the correct LRN corresponding to the search key. Checksums may be used to indicate whether entries are corrupt or not. However, the checksums only indicate whether data is corrupt-not whether the data contains the correct LRN.

Another problem associated with data validation is data recovery. B-tree structures cannot be recovered in smaller data blocks since entries in such a structure relate to each other as branches. This forces a reload of the entire database when data is identifies as invalid. There exists a need to identify corrupt small data blocks and recover the smaller blocks of data, eliminating the need to reload an entire database.

Still another problem associated with conventional telecommunications databases is the presence of sparse data. Sparse data refers to data that occupies only a portion of a block of memory reserved for data within a range. For example, a block of memory may be reserved to store LRNs corresponding to keys within a range. If only a small number of TNs within the range are ported, the remaining space within the block is wasted. Thus, there exists a need for a method for consolidating sparse data.

Another problem with telecommunications databases is the high rate of updates for the databases. Databases require updates to be applied one update at a time and in sequence. There exists a need to apply cumulative updates for data blocks. There also exists a need to be able to apply updates that may not be in sequence. This would eliminate the need to slow down updates when database systems are operating inefficiently or cannot be updated for any period of time.

Accordingly, in light of these difficulties associated with conventional databases that are indexed by range-bound numeric data, there exists a need for improved methods, systems, and computer program products for indexing, validating, recovering, and consolidating a database indexed by range-bound numeric data.

### SUMMARY

According to one aspect, the subject matter described herein includes a method for accessing a database indexed by range-bound numeric data. The method includes computing at least one index based on a first key within a first range of numeric data. An entry corresponding to the at least one index is accessed. From the entry, a bitmap having bits indicating presence or absence of data corresponding to different keys in the first range of numeric data is read. Data corresponding to the first key is located using the bitmap.

According to another aspect, the subject matter described herein includes a method for validating results of a search in a database indexed by range-bound numeric data. The method includes storing a portion of a search key in a database indexed by range-bound numeric data. The database is accessed by computing at least one index based on the search key. An entry in the database corresponding to the at least one index is located. The search key portion is compared to a stored search key portion in the entry. If the search key portion used to access the database matches the stored search key portion, the database access is valid and a result is returned. If the stored search key portion does not match the search key portion used to perform the access, the database access result may be indicated as invalid.

According to another aspect, the subject matter described herein includes recovery of invalid data blocks associated with bit maps.

According to another aspect, the subject matter described herein includes a method for consolidating sparse data in a database indexed by range bound numeric data. The method may include storing blocks of data indexed by ranges of numbers. Each block of data may include individual entries corresponding to keys within each range. For each block of data, a count, a pointer, and a bitmap may be stored. The count may indicate a number of populated entries within each block. The pointer may point to each block. The bitmap may include bits indicating populated and unpopulated entries within each block. Blocks with unpopulated entries may be consolidated using the counts and the bitmaps.

According to another aspect, the subject matter described herein includes a system for providing bounded access time for telecommunications number portability database accesses. The system includes a number portability database including a plurality of range tables and a data table. Each range table includes entries corresponding to ranges of digits in telephone numbers. The data table includes entries containing number portability information. A database access engine computes indices to the range tables using different portions of a telephone number for which number portability information is sought and locates, using the indices and data read from the range tables, an entry in the data table containing number portability information for the telephone number.

The subject matter described herein for indexing, validating, recovering, and consolidating data in a database indexed by range-bound numeric keys may be implemented using a computer program product comprising computer executable instructions embodied in a computer readable medium. Exemplary computer readable media suitable for implementing the subject matter described herein include chip memory devices, disk memory devices, programmable logic devices, application specific integrated circuits, and downloadable electrical signals. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a block diagram illustrating an exemplary operating environment for embodiments of the subject matter described herein;

FIG. 2 is a flow chart illustrating exemplary steps for accessing data in a database indexed by range-bound numeric data according to an embodiment of the subject matter described herein;

FIG. 3 is a data structure diagram illustrating an exemplary structure for a database indexed by range-bound numeric data according to an embodiment of the subject matter described herein;

FIGS. 4A and 4B are a flow chart illustrating exemplary steps for accessing data in the database structure illustrated in FIG. 3 according to an embodiment of the subject matter described herein;

FIG. 5 is a flow chart illustrating exemplary steps for validating results of access to a database indexed by range-bound numeric data according to an embodiment of the subject matter described herein; and

FIG. 6 is a flow chart illustrating exemplary steps for consolidating sparse data in a database indexed by range-bound numeric data according to an embodiment of the subject matter described herein.

### DETAILED DESCRIPTION OF THE INVENTION

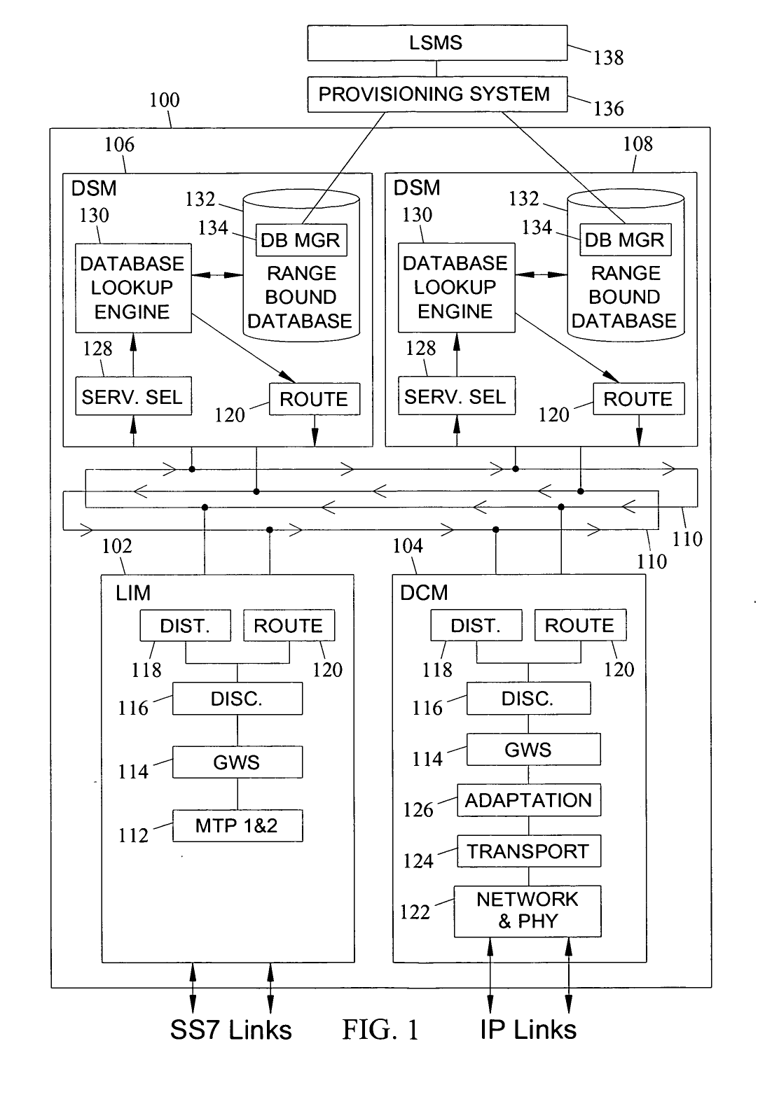

The subject matter described herein for indexing, validating, recovering, and consolidating data in a database indexed by range-bound keys can be implemented on any suitable hardware platform that includes such a database. In the telecommunications industry, examples of such hardware platforms include signal transfer points (STPs), service control points (SCPs), service switching points (SSPs), home location registers (HLRs), visitor location registers (VLRs), short message service centers (SMSCs), database provisioning platforms, or Internet protocol (IP) telephony signaling nodes, such as media gateways, IP-based database nodes, etc. FIG. 1 is a block diagram illustrating an exemplary internal architecture of a signal transfer point that includes a database access engine and a range-bound database according to an embodiment of the subject matter described herein. Referring to FIG. 1, STP 100 includes a plurality of internal processing modules 102-108 connected to each other via a counter-rotating, dual-ring bus 110. Processing modules 102-108 may each include an application processor and associated memory for implementing a telecommunications signaling function. In addition, each processing module may include a communications processor for communicating with other processing modules via bus 110.

In the illustrated example, processing module 102 comprises a link interface module (LIM) for interfacing with SS7 signaling links. Link interface module 102 includes a message transfer part (MTP) level 1 and 2 function 112, a gateway screening function 114, a discrimination function 116, a distribution function 118, and a routing function 120. MTP level 1 and 2 function 112 performs MTP level 1 and 2 operations, such as error correction, error detection, and sequencing of SS7 signaling messages. Gateway screening function 114 screens incoming SS7 signaling messages based on one or more parameters in the messages. Discrimination function 116 determines whether a received SS7 signaling message should be distributed to another processing module within STP 100 for further processing or whether the message should be routed over an outbound signaling link. Discrimination function 116 forwards messages that are to be distributed for internal processing to distribution function 118. Distribution function 118 forwards the messages to the appropriate internal processing module. Routing function 120 routes messages that are required to be routed based on MTP level 3 information in the messages.

Processing module 104 comprises a data communications module (DCM) for sending and receiving signaling messages via IP signaling links. DCM 104 includes a network and physical layer function 122, a transport layer function 124, an adaptation layer function 126, and layers 112-120 described with regard to LIM 102. Network and physical layer function 122 performs network and physical layer functions for sending and receiving messages over IP links. For example, function 122 may implement Internet protocol (IP) over Ethernet. Transport layer function 124 implements transport layer functions. For example, transport layer function 124 may implement transmission control protocol (TCP), user datagram protocol (UDP), or stream control transmission protocol (SCTP). Adaptation layer function 126 performs operations for adapting signaling messages, such as SS7 signaling messages, for transport over an IP network. Adaptation layer function 126 may implement using any of the IETF adaptation layer protocols, such as M3UA, M2PA, SUA, TALI, or other suitable adaptation layer protocol. Functions 114-120 perform the operations described above for the correspondingly numbered components of LIM 102.

Processing modules 106 and 108 are database service modules (DSMs) for providing database services for received signaling messages. Each DSM 106 and 108 includes a service selection function 128 for determining the type of database service to be applied to a received signaling message. Once a service is selected, a database access engine 130 accesses services in a range-bound database 132 corresponding to the selected service. After the database access has been performed, routing function 120 may route the received signaling message or a response to a received signaling message to its destination.

Database access engine 130 may implement the indexing methods described herein for accessing data in database 132. In addition, database access engine 130 may perform validation of database access results at access time based on data stored in database 132. A database manager 134 may communicate with an external database provisioning platform 136 to provision database 132 and perform the steps described herein for consolidating sparse data in database 132. If database 132 comprises a local number portability database, provisioning system 136 may receive number portability data from local service management system (LSMS) 138. Local service management system 138 may receive its number portability information from a number portability administration center (NPAC), which distributes number portability information on a national or regional level. Provisioning system 136 may maintain its own local copy of range-bound database 132. Provisioning system 136 may perform insertions and deletions in its copy of database 132 based on data received from LSMS 138. Provisioning system 136 distributes its copy of database 132 to DSM cards 106 and 108. Accordingly, provisioning system 136 may include a database access engine 130 and a copy of range-bound database 132.

In prior implementations where range-bound database 132 was implemented using a binary tree, provisioning system 136 was required to sequentially and individually distribute number portability entries to range-bound databases 132 on DSM cards 106 and 108. However, as will be described in detail below, range-bound database 132 uses a multi-level index structure, rather than a b-tree. Accordingly, provisioning system 136 can distribute large blocks of number portability entries regardless of the order in which the entries are received from LSMS 138. Simultaneously sending blocks of more than one number portability entry to range-bound database 132 decreases the time required for database synchronization over conventional b-tree-based synchronization methods where entries are sent sequentially by provisioning system 136. Such synchronization is particularly important when DSM cards 106 and 108 reboot and must reload range-bound databases 132 from scratch.

Database 132 may be any suitable database in which entries are indexed by ranges of numbers. Examples of such databases include number portability databases, such as local number portability databases or mobile number portability databases, and databases of mobile telecommunications node addresses indexed by mobile subscriber identifiers, such as IMSIs or MSISDN numbers. Alternatively, database 132 may be indexed by non-numeric identifiers, such as session initiation protocol (SIP) uniform resource indicators (URIs) or uniform resource locators (URLs). In such an implementation, database access engine 130 may compute a hash of a search key to implement the index-based access methods described herein.

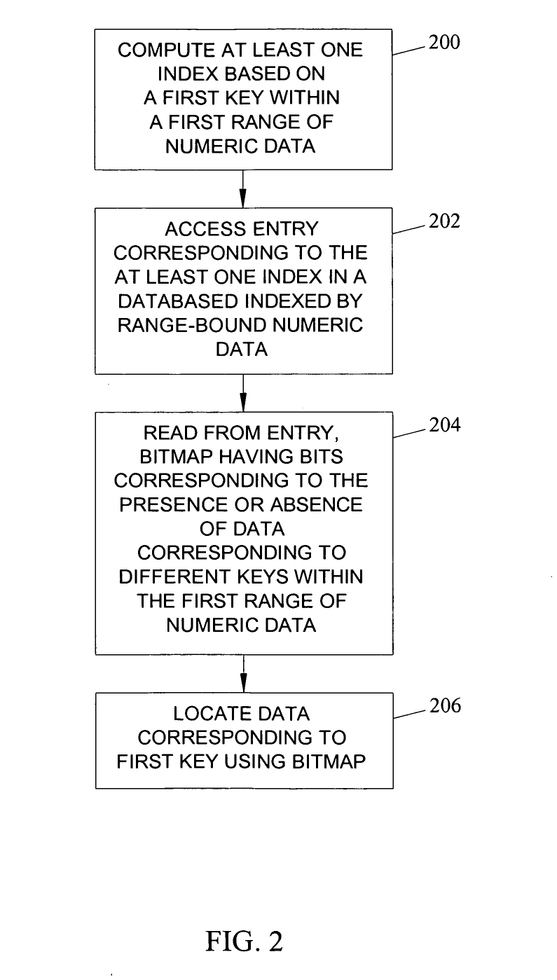

FIG. 2 is a flow chart illustrating exemplary overall steps for indexing data in a range-bound database, such as database 132 illustrated in FIG. 1. Referring to FIG. 2, in step 200, a database access engine, such as database access engine 130, computes at least one index based on a first search key that falls within a first range of numeric data. For example, the search key may be a telephone number and at least one index may include an index based on a portion of the key, such as the NPA-NXX portion. Different indexes may be computed based on different portions of the search key, as will be described in detail below. In step 202, the database access engine 130 accesses an entry corresponding to the at least one index in the database. Rather than performing comparisons to locate a database entry, a database access engine according to an embodiment of the subject matter described herein may perform a computation based on a portion of the search key and proceed directly to an entry corresponding to the computation result. For example, if the digits of a search key are “450,” and each entry in a database is indexed by ranges of 100 numbers starting at 000, the computation may include adding 1 to the hundreds digits of 450 and proceeding to the fifth entry in the database. A detailed example of index calculation will be described below.

In step 204, database access engine 130 reads, from the entry, a bitmap having bits that correspond to the presence or absence of data corresponding to different keys within the first range of numeric data. For example, in a number portability environment, each bit in the bitmap may indicate whether or not a number within a range of numbers is ported. If the bit indicates that a number corresponding to an access key is not ported, then further database access is not required. If the bit indicates that the number is ported, control will proceed to step 206 where the data is located using the bitmap.

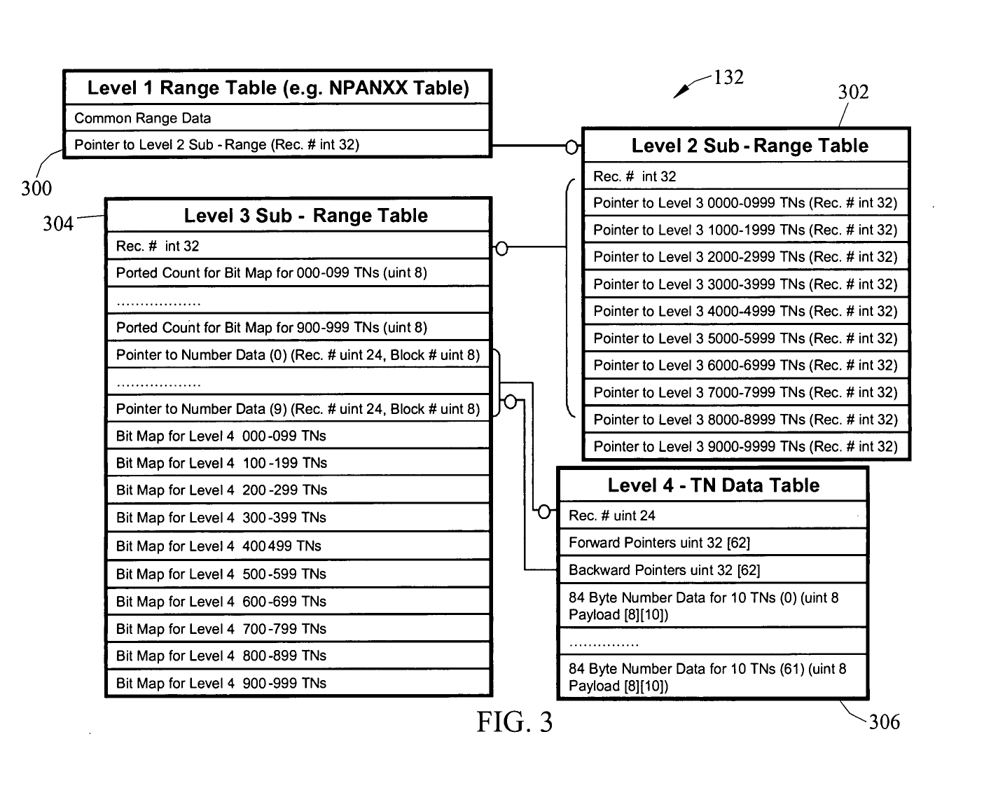

FIG. 3 is a block diagram illustrating an exemplary data structure that may be used in a range-bound database, such as database 132, according to an embodiment of the subject matter described herein. Referring to FIG. 3, database 132 includes a level 1 range table 300, a level 2 sub-range table 302, a level 3 sub-range table 304, and a level 4 TN data table 306. Tables 300-306 illustrated in FIG. 3 will be explained with regard to number portability data. However, it should be noted that the structure of these tables can apply to any type of data where entries are indexed by ranges of numbers. In the illustrated example, level 1 range table 300 may include entries indexed by NPA-NXX values. For illustrative purposes, a single entry is shown. In the illustrated example, the entry includes a pointer to a record in level 2 sub-range table 302. Each entry in level 2 sub-range table 302 is indexed by ranges of 1000 numbers from 0000 to 9999, corresponding to the last four digits of a telephone number used as a search key. Each entry in level 2 sub-range table 302 includes a pointer to an entry in level 3 sub-range table 304 for the corresponding range. Level 3 sub-range table 304 includes entries indexed by ranges of 100 numbers from 000 to 999 corresponding to the last three digits of a telephone number. Each entry in level 3 sub-range table 304 includes a bitmap, a ported count, and a pointer to level 4 data table 306. The ported count for each entry indicates the number of TNs within each range that are ported. The bitmap includes bits that indicate the presence or absence of data for a key corresponding to each bit. The pointer points to the block of data in level 4 TN data table 306 corresponding to each range in level 3 sub-range table 304. Level 4 TN data table 306 includes the data desired to be accessed. For example, for number portability data, level 4 TN data table 306 may include an LRN and MRG data. In addition, level 4 data table 306 may include a portion of a search key, such as the NPA-NXX value, so that results of a database access can be validated at access time.

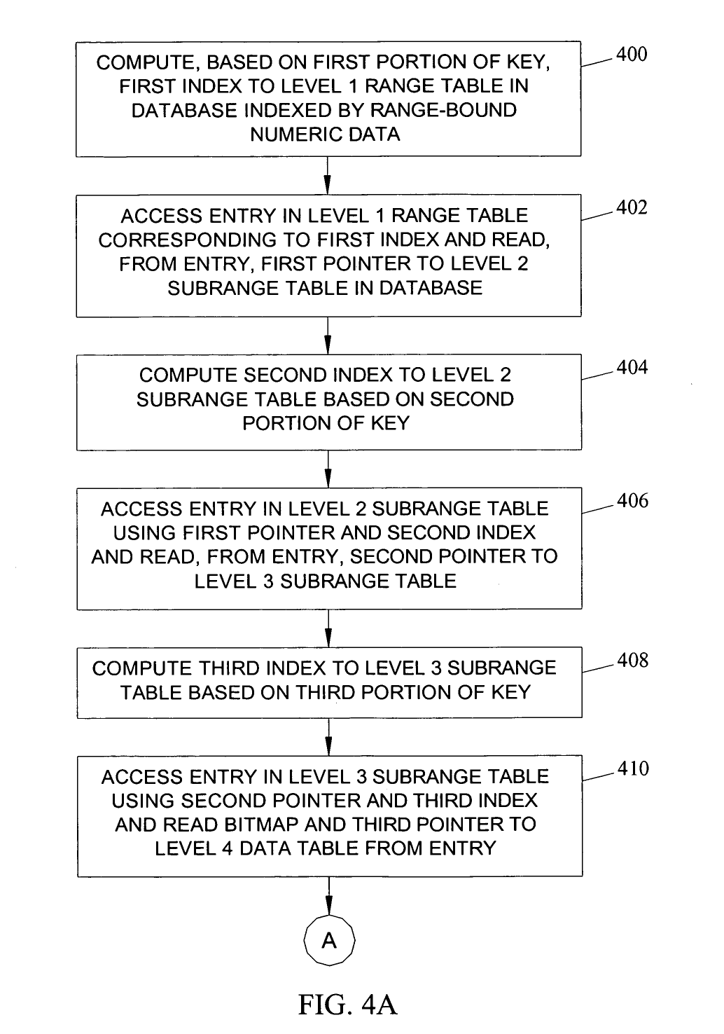

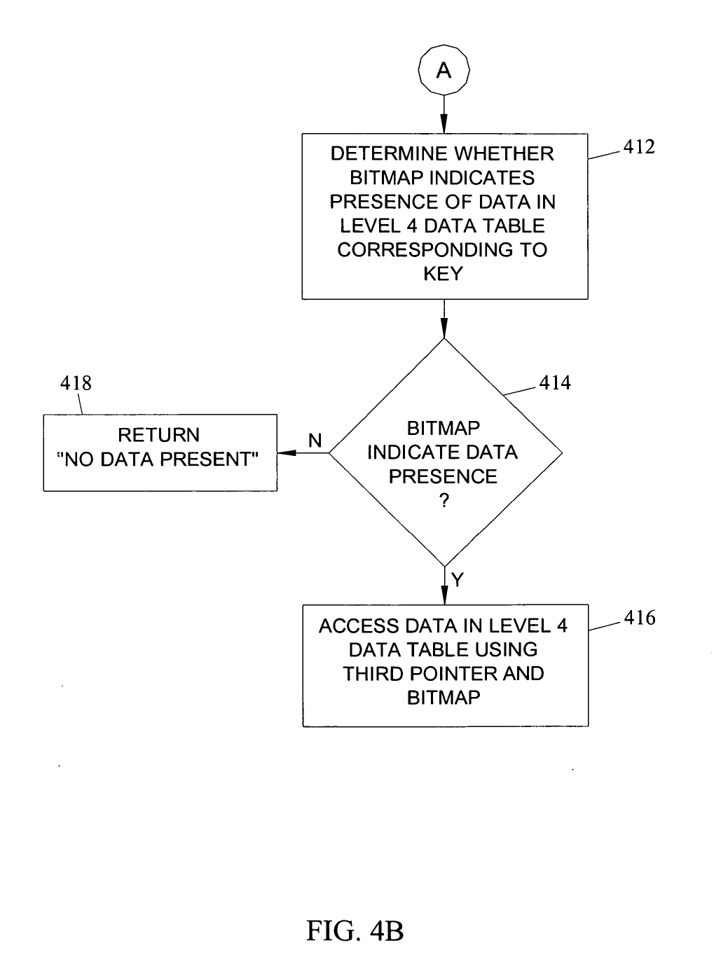

FIGS. 4A and 4B are a flow chart illustrating detailed steps for accessing data indexed by range-bound keys using the data structure illustrated in FIG. 3 according to an embodiment of the subject matter described herein. Referring to FIG. 4A, in step 400, a first index is computed based on a first portion of a key. The first index is an index to level 1 range table 300 in the database. Using the data structure illustrated in FIG. 3 as an example, if the numeric key is 919-380-2450, the first index may be computed based on the NPA-NXX portion of the number or 919-380. The first index is the value 919-380 that points to the row 919380 in level 1 range table. If any telephone numbers with NPA-NXX value of 919-380 are ported, row 919380 in the level 1 range table will have a pointer to a row in level 2 range table.

In step 402, the entry in the level 1 range table corresponding to the first index is accessed, and a pointer to a level 2 sub-range table is located. Continuing with the example, the NPA-NXX value of 919-380 will result in an entry in the level 1 sub-range table that contains a pointer to a record in level 2 sub-range table 302. The record may include multiple entries. In order to access the appropriate entry, in step 404, a second index is computed to the level 2 sub-range table based on a second portion of the key. Since the entries in level 2 sub-range table 302 correspond to the last four digits of the TN, the second index may be computed, based on 2450 from the search key. Since level 2 sub-range table 302 is sequentially arranged, the appropriate entry may be accessed by adding one to the 1000s digit of the phone number. Using 2450 as example, since 2+1=3, the third entry in level 2 sub-range table 302, may be accessed.

In step 406, the entry in the level 2 sub-range table corresponding to the first pointer and the second index is accessed. A pointer to a record in level 3 sub-range table 304 is read. In step 408, a third index is computed based on a third portion of the key. Since entries in the extracted record from level 3 sub-range table 304 are arranged in increments of 100 telephone numbers, the last three digits of the telephone number are used to compute the third index. In this example, the last three digits of the telephone number are 450. If one is added to the 100s digit, the result is 5, and the fifth entry in the table will be accessed.

In step 410, an entry in the level 3 sub-range table is accessed using the second pointer in the third index. From the entry, a bitmap and a third pointer to a block of data in level 4 data table 306 corresponding to the level 3 sub-range table entry are read. The pointer points to the level 4 TN data table entry that contains number portability data for a range of numbers within each the search key falls. The bitmap includes 100 bits, one for each key within the range of TNs of the entry in level 3 sub-range table 304, where each bit indicates the presence or absence of number portability data corresponding to each key in level 4 TN data table 306.

In steps 412 and 414 in FIG. 4B, it is determined whether the bitmap indicates the presence of data corresponding to the key in level 4 TN data table 306. In this example, since the last three digits of the TN being analyzed are 450, and the bitmap includes one bit for each number from 400-499, the fifty-first bit of the bitmap is analyzed. If the fifty-first bit indicates the presence of number portability data, control proceeds to step 416 where the number portability information is accessed in level 4 data table 306 using the pointer and the bitmap. The pointer points to the appropriate data block in the level 4 data table. The bitmap allows the database access engine to calculate the appropriate entry. For example, number portability data table entries may be arranged sequentially starting from the first TN that has a ported number and ending on the last TN that has a ported number within the given range. In order to calculate the location of the appropriate entry, the database access engine may count the number of ported bits in the bitmap before the fifty-first bit. If there are ten bits indicating ported numbers before the fifty-first bit, then the entry corresponding to the number 919-380-2450 will be the eleventh entry in level 4 TN data table 306. In step 414, if the bitmap indicates that number portability data is not present for the TN, control may proceed to step 418 where the access engine returns not ported or no data present.

Because the database is accessible through a series of computations based on different portions of the TN used to perform the lookup, the time to access data in the database is bounded, even as the number of ported numbers added to the database increases. For example, the lookup time depends on the number of computations required to be performed on the search key and the time to access the entries each table rather than the time required to traverse branches in a b-tree, which increase in number as ported numbers are added to the database.

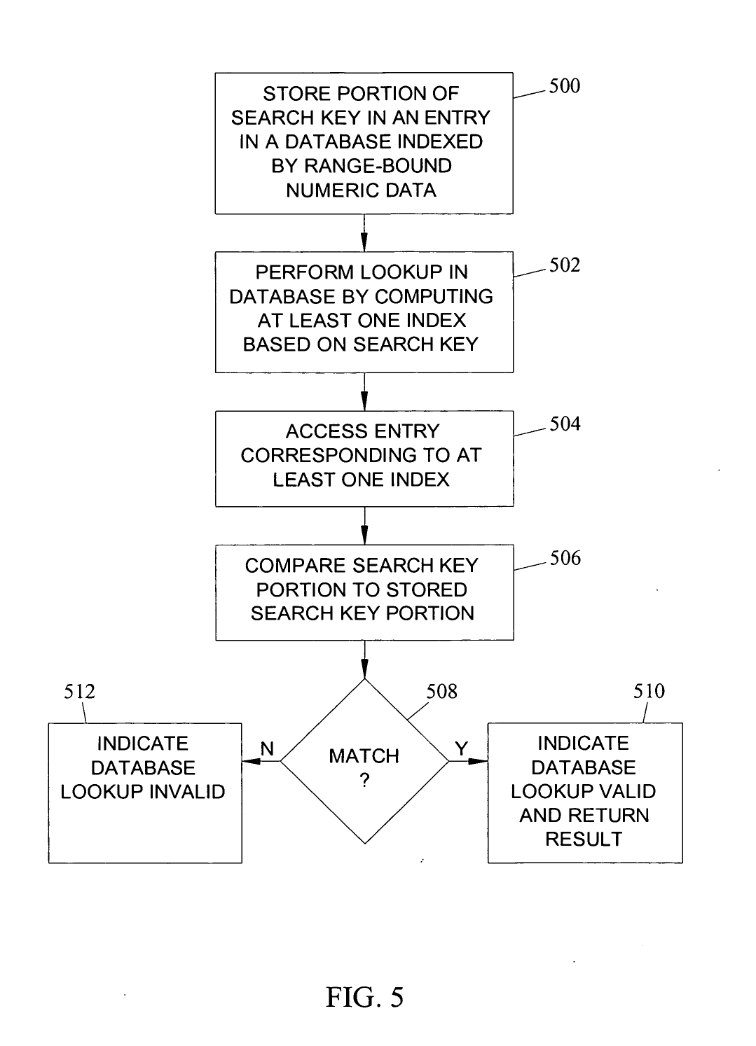

According to another aspect of the subject matter described herein, results of a database access may be validated at access time. FIG. 5 is a flow chart illustrating exemplary steps for validating results of a database access at access time. Referring to FIG. 5, in step 500, a portion of a search key is stored in a database indexed by range-bound numeric data. Using number portability as an example, the NPA-NXX may be stored in an entry of level 4 TN data table 306 illustrated in FIG. 3 to validate results of a database access. In step 502, the database is accessed by computing at least one index based on the search key. The access may be performed using the steps described above with regard to FIGS. 4A and 4B. In step 504, an entry in the database is accessed using the index. For example, the entry in level 4 TN data table 306 may be accessed. In step 506, the search key portion used to perform the access, e.g., the NPA-NXX value, may be compared to the stored search key portion. If there is a match, control proceeds to step 510 where the database access results are indicated as valid and the result is returned. If there is not a match, control proceeds to step 512 where the database access results are indicated as invalid.

According to another aspect, when invalid data exists in a database, the entire database needs to be reloaded into memory. The subject matter described herein recognizes invalid data in blocks of memory as described above. Data blocks containing invalid data may be recovered, resulting in eliminating the need to reload an entire database. In the above example, if the portability data for telephone number 919-380-2450 is invalid, only the data block in level 4 TN table containing the invalid data needs to be recovered. The data can be recovered by replacing the data for the invalid entry in the level 4 TN table with valid data from a local or remote copy of the database. The recovery may be performed by the database access engine.

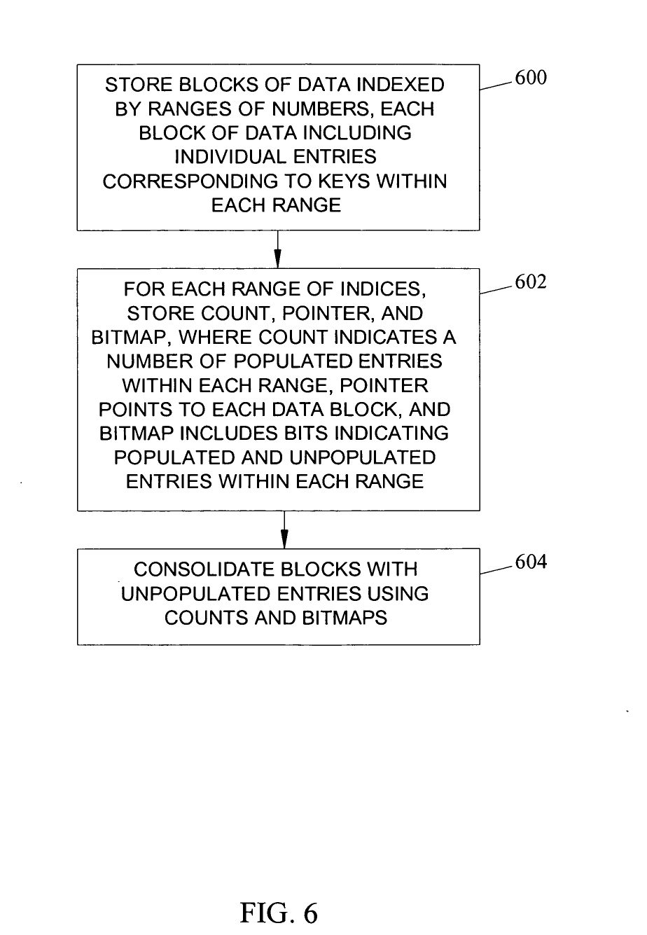

According to another aspect, the subject matter described herein may include a method for consolidating sparse data. Sparse data refers to a data within a block of reserved memory that occupies less than the entire block. For example, if a block of memory is reserved to store data for ported numbers within a range of one hundred TNs and only one number in the range is ported, the data would be considered to be sparse. Since it is desirable to avoid sparse data, the subject matter described herein includes a method for consolidating sparse data. FIG. 6 is a flow chart illustrating exemplary steps for consolidating sparse data according to an embodiment of the subject matter described herein. Referring to FIG. 6, in step 600, blocks of data indexed by ranges of numbers are stored in a database. Each block of data includes individual entries corresponding to keys in each range. For example, each block of data in TN data table 306 may include a predetermined number of TN records. For purposes of illustration, it will be assumed that each block includes one hundred TN records as is the case in level 4 data table 306 illustrated in FIG. 3. Each one-hundred-TN record may include populated entries, i.e., entries for which number portability data is present, and unpopulated entries, i.e., entries for which number portability data is not present because the number is not ported.

In step 602, for each range of indices, a count, a pointer, and a bitmap are stored. The count indicates the number of populated entries within each range. The pointer points to each block of data in level 4 TN data table 306, and the bitmap includes bits indicating whether each entry is populated or unpopulated. As illustrated in FIG. 3, level 3 sub-range table 304 stores a bitmap and a pointer to blocks in level 4 TN data table 306 as described above. In addition, level 3 sub-range table 304 may include a ported count for each block. In step 604, blocks with unpopulated entries are consolidated using the counts and the bitmaps. Consolidating the blocks using the counts and bitmaps may include moving number portability data in table 306 from one block with unpopulated entries to another block with unpopulated entries. When this occurs, the pointer in table 304 to the source block will be changed to point to the destination block. The bitmaps for both blocks may be separately maintained in level 3 sub-range table 304. However, the ported count maintained in table 304 for the destination block will be changed to reflect the cumulative ported count of all blocks before the current block. Table 1 shown below illustrates an example of data structure changes that may be made in level 3 sub-range table 304 according to an embodiment of the subject matter described herein.

TABLE 1
Data Structure for Consolidating Blocks of Ported Numbers

| Entry in Level 3 | | | |
|---|---|---|---|
| TN Table | Ported Count | Pointer | Bitmap |
| 000-999 | 0 | 0x5E | 00010000 . . . |
| 100-199 | 3 | 0x5E | 01010000 . . . |
| 200-299 | 6 | 0x5E | 01000110 . . . |
| 300-399 | 6 | 0x5E | 0000000 . . . |
| 400-499 | 6 | 0x5E | 00000000 . . . |
| 500-599 | 9 | 0x5E | 01110000 . . . |
| 600-699 | 10 | 0x5E | 10000000 . . . |
| 700-799 | 12 | 0x5E | 11000000 . . . |
| 800-899 | 13 | 0x5E | 10000000 . . . |
| 900-999 | 13 | 0x5E | 00000000 . . . |

In Table 1, the first column indicates the ranges by which entries in level 3 sub-range table 304 are indexed. The second column stores the cumulative ported count for the current block and any blocks preceding the current block. The third column stores a pointer to each block. It should be noted that all of the pointers point to the same block indicating that the blocks are consolidated.

The bitmap includes bits in the locations of ported entries within the original blocks before consolidation. The location of ported entries in level 4 data blocks after consolidation can be derived from the bitmaps and the cumulative ported counts. For example, if the last three digits of a TN are 201, the third row in Table 1 will be accessed. Since the last two digits 01 in the TN correspond to the second bit in the bitmap, which is a 1, the number is ported. The cumulative ported count for the row is 6 and the pointer is 0x5E. Accordingly, the seventh entry in the block of data in level 4 data table 306 corresponding to the pointer 0X5E will be accessed.

According to another aspect, the subject matter described herein provides a method to update bit maps and data blocks that contain data pointed to by the bit maps. When updates are received, bit maps and data blocks are both updated. In the example shown in Table 1 above, if 5 updates are received for the bit maps indicated in Table 1, the entry shown above in Table 1 for Level 3 table and the data block pointed to by memory location 0x5E are both updated. The 5 updates need not be sent sequentially. The 5 updates may be sent in a single cumulative update.

According to another aspect, the subject matter described herein includes a method for accessing data in a database indexed by range-bound data where the keys used to perform the access are of non-numeric data. In order to access a database using non-numeric data, one method includes converting the non-numeric keys to range bound numeric keys and using the numeric keys to perform the access. For example, if a telecommunications database is indexed by a non-numeric indicator, such as a SIP URI, the URI can be converted into numeric key by using a hash algorithm such as the MD5 hash algorithm. If the SIP URI is rohini@tekelec.com, the portion “rohini” may be hashed and treated similarly to the last four digits of a telephone number as described above. The tekelec.com portion of the address may be hashed and the results may be treated as the NPA-NXX portion of the number. The hash output for these two portions may be used to access the database as described above.

One problem with using hash functions to convert non-numeric data to numeric data is collisions. In hash functions, output is supposed to be unique for different inputs. However, two different inputs may hash to the same output, which is referred to as a collision. In order to access data in a database when a collision occurs, a collision table may be maintained. Table 2 shown below illustrates exemplary data that may be stored in such a table.

TABLE 2
Collision Table

| Hash Output | Hash Input | L2 Pointer | Hash Input | L2 Pointer |
|---|---|---|---|---|
| 919380 | tekelec.com | 0x02 | vz.com | 0x04 |

In Table 2, the first column stores the hash function output, which for illustrative purposes is shown as 919380. The second column stores the first hash input corresponding to the hash output, which in this example is tekelec.com. The third column in the Table contains the pointer to the level 2 sub-range table for the hash input in the second column. The third column in the collision table stores the second hash input that corresponds to the same hash output. In this example, the second hash input is the domain vz.com. The final column in the table stores the pointer to the entry in the level 2 sub-range table that corresponds to the second hash input. Accordingly, if a collision occurs, data, such as that illustrated in Table 2 can be used to resolve the collision.

It will be understood that various details of the invention may be changed without departing from the scope of the invention. Furthermore, the foregoing description is for the purpose of illustration only, and not for the purpose of limitation.

1. A method for indexing a database indexed by range-bound numeric data, the method comprising:
(a) computing at least one first index based on a first key within a first range of numeric data;
(b) accessing an entry corresponding to the index in a database having entries that are indexed by range-bound numeric data;
(c) reading, from the entry, a bitmap having bits indicating the presence or absence of data corresponding to different keys within the first range of numeric data; and
(d) locating data corresponding to the first key using the bitmap.

2. The method of claim 1 wherein the first key comprises a numeric key.

3. The method of claim 2 wherein the first key comprises a telephone number and the first range comprises a range of telephone numbers.

4. The method of claim 1 wherein the database comprises a number portability database indexed by ranges of telephone numbers.

5. The method of claim 4 wherein the number portability database comprises a local number portability database indexed by ranges of telephone numbers and wherein the data corresponding to the first key comprises a location routing number (LRN).

6. The method of claim 4 wherein the number portability database comprises a mobile number portability database and wherein the data comprises mobile telecommunications node addresses.

7. The method of claim 1 wherein the database comprises a mobile telecommunications node address database indexed by ranges of and individual mobile subscriber identifiers.

8. The method of claim 1 wherein the first key comprises a non-numeric key and wherein the method further comprises converting the non-numeric key to a numeric key by computing a hash of at least a portion of the first key.

9. The method of claim 1 wherein computing at least one index includes:
(a) computing a first index to a first level range table of the database based on a first portion of the key;
(b) accessing an entry in the first level range table corresponding to the first index and reading, from the entry, a first pointer to a second level sub-range table;
(c) computing a second index to a second level sub-range table in the database based on a second portion of the key;
(d) accessing an entry in the second level sub-range table corresponding to the second index and locating a second pointer to a third level sub-range table in the database;
(e) computing a third index to the third level sub-range table based on a third portion of the key; and
(f) accessing an entry in the third level sub-range table corresponding to the third index, wherein the entry in the third level sub-range table includes the bitmap and a fourth pointer, wherein locating data corresponding to the first key using the bitmap includes locating data corresponding to the first key using the bitmap and the fourth pointer.

10. A method for validating results of access to a database indexed by range-bound numeric data, the method comprising:
(a) storing a portion of a search key in an entry in a database indexed by range-bound numeric data;
(b) accessing an entry in the database by computing at least one index based on a search key;
(c) locating an entry in the database corresponding to the at least one index;
(d) reading a portion of a search key stored in the entry; and
(e) determining whether results of the access are valid based on the portion of the search key stored in the entry and the search key used to perform the access.

11. The method of claim 10 wherein the search key comprises a numeric key.

12. The method of claim 11 wherein the search key comprises a telephone number.

13. The method of claim 10 wherein the database comprises a number portability database.

14. The method of claim 13 wherein the database comprises a local number portability database.

15. The method of claim 13 wherein the database comprises a mobile number portability database.

16. The method of claim 10 wherein the database comprises a database of mobile telecommunications node addresses indexed by ranges of mobile subscriber identifiers.

17. The method of claim 10 wherein the search key comprises a non-numeric key and wherein accessing the database using the search key computing a hash of the search key and accessing the database using results of the hash operation.

18. The method of claim 10 wherein accessing in the database using the search key comprises, locating a bitmap using the at least one index, the bitmap indicating the presence of populated and unpopulated entries in the database, and locating an entry for the search key using the bitmap.

19. The method of claim 10 comprising, in response to determining that results of the database access are invalid, recovering data in the entry corresponding to the invalid results.

20. The method of claim 19 wherein recovering data in the entry corresponding to the invalid results includes replacing the data corresponding to the invalid results in the entry without reloading the entire database.

21. A method for consolidating sparse data in a database indexed by range bound numeric data, the method comprising:
(a) storing blocks of data indexed by ranges of numbers, each block of data including individual entries corresponding to a number within a range;
(b) storing a count, a pointer, and a bitmap for each range of numbers, the count indicating a number of populated entries within each range, the pointer pointing to each block, and the bitmap including bits that indicate populated and unpopulated entries within each range; and
(c) consolidating blocks having unpopulated entries using the counts and the bitmaps.

22. The method of claim 21 wherein the database is indexed by ranges of telephone numbers.

23. The method of claim 21 wherein the database comprises a number portability database.

24. The method of claim 23 wherein the number portability database comprises a local number portability database.

25. The method of claim 23 wherein the database comprises a mobile number portability database.

26. The method of claim 21 wherein the database comprises a mobile telecommunications node address database indexed by ranges of and individual mobile subscriber identifiers.

27. The method of claim 21 wherein consolidating blocks with unpopulated entries using the counts and the bitmaps comprises:
(a) identifying blocks having bitmaps including unpopulated entries;
(b) merging the blocks having unpopulated entries; and
(c) updating the counts for the ranges to represent a cumulative count of populated entries in each range and ranges preceding each range.

28. A database system for providing access to a database indexed by range bound numeric data, the system comprising:
(a) a database for storing data indexed by range-bound numeric data; and
(b) a database access engine for computing at least one index based on a first key within a first range of numeric data, for accessing an entry in the database corresponding to the index, for reading from the entry, a bitmap having bits indicating the presence or absence of data corresponding to different keys within the first range of numeric data, and for locating data corresponding to the first key using the bitmap.

29. The system of claim 28 wherein the first key comprises a numeric key.

30. The system of claim 28 wherein the first key comprises a telephone number within a range of telephone numbers.

31. The system of claim 28 wherein the database comprises a number portability database.

32. The system of claim 31 wherein the database comprises a local number portability database.

33. The system of claim 31 wherein the number portability database comprises a mobile number portability database.

34. The system of claim 28 wherein the database comprises a database of mobile subscriber node addresses indexed by ranges of and by individual mobile subscriber identifiers.

35. The system of claim 28 wherein the database access engine is adapted to compute a hash of a non-numeric key and to use the hashed key to access the database.

36. The system of claim 28 wherein the database access engine is adapted to:
(a) access a first entry in a level one range table of the database corresponding to the first index and read, from the first entry, a first pointer to a second level sub-range table in the database;
(b) compute a second index to the second level sub-range table based on a second portion of the key;
(c) access an entry in the second level sub-range table corresponding to the second index and locate a second pointer to a third level sub-range table in the database;
(d) computing a third index to the third level sub-range table based on a third portion of the key;
(e) access an entry in the third level sub-range table corresponding to the third index and to read a bitmap and a fourth pointer from the entry; and
(f) locate the data corresponding to the first key using the bitmap and the fourth pointer.

37. The system of claim 28 comprising a provisioning platform operatively associated with the database for receiving database updates and for communicating blocks including a plurality of database updates to the database.

38. The system of claim 37 wherein the database access engine is adapted to perform cumulative updates to blocks of data in the database and to bitmaps that point to the blocks.

39. A system for providing bounded access time for telecommunications number portability database accesses, the system comprising:
(a) a number portability database including a plurality of range tables and a data table, each range table including entries corresponding to ranges of digits in telephone numbers and the data table including entries containing number portability information; and
(b) a database access engine for computing indices to the range tables using different portions of a telephone number for which number portability information is sought and for locating, using the indices and data read from the range tables, an entry in the data table containing number portability information for the telephone number.

40. The system of claim 39 wherein the range tables include a level one range table including entries indexed by the NPA-NXX portion of a telephone number.

41. The system of claim 40 wherein the range tables include a level two sub-range table including entries indexed by the last four digits of a telephone number.

42. The system of claim 41 wherein the range tables include a level three sub-range table including entries indexed by the last three digits of a telephone number.

43. The system of claim 42 wherein the data table comprises a level four data table indexed by information derived from the entries in the level three range table and containing the number portability information.

44. The system of claim 43 wherein each entry in the level three sub-range table includes a pointer to a block of data in the level four data table and a bitmap indicating entries in the block of data that contain number portability information.

45. The system of claim 44 wherein the database access engine is adapted to determine, based on the bitmap, the location of the number portability information for the telephone number used to access the database.

46. A computer program product comprising computer executable instructions embodied in a computer readable medium for performing steps comprising:
(a) computing at least one first index based on a first key within a first range of numeric data;
(b) accessing an entry corresponding to the index in a database having entries that are indexed by range-bound numeric data;
(c) reading, from the entry, a bitmap having bits indicating the presence or absence of data corresponding to different keys within the first range of numeric data; and
(d) locating data corresponding to the first key using the bitmap.
